(19) United States
(12) Patent Application Publication
(10) Pub. No.: US 2016/0369987 A1
(43) Pub. Date: Dec. 22, 2016

(54) LED Lighting Apparatus

(71) Applicant: Dongbu Lightec Co., LTD., Gyeonggi-do (KR)

(72) Inventors: Seok Hyun Kim, Gyeonggi-do (KR); Young Woo Cho, Gyeonggi-do (KR)

(21) Appl. No.: 14/833,724

(22) Filed: Aug. 24, 2015

(30) Foreign Application Priority Data
Jun. 22, 2015 (KR) 10-2015-0088646

(51) Int. Cl. F21V 23/00; F21V 17/00; F21V 17/12

(52) U.S. Cl. CPC F21V 23/009; F21V 17/12; F21V 17/002; F21Y 2103/003

(57) ABSTRACT

Disclosed is an LED lighting apparatus with a power supply unit. The LED lighting apparatus may include: a case configured to accommodate the power supply unit; a cover configured to be in close contact with the case so that the power supply unit is shielded; a stationary bracket configured to be coupled to the case, and including a fixing plate that is flat in a horizontal direction; and a rotary bracket configured to be coupled to the cover and to be rotated about a rotary axis orthogonal to a plane formed by the fixing plate, and including a locking plate that is parallel to the fixing plate. As the rotary bracket is rotated, the cover is separated from the case in a first range where the fixing plate and the locking plate are separated from each other, and the cover is fixed to the case in a second range where the fixing plate and the locking plate are engaged with each other. According to the present disclosure, it is possible to provide an LED lighting apparatus, in which the separation and coupling of the cover can be readily performed by the coupling structure of the stationary bracket and the rotary bracket, the loss of some parts can be prevented when the cover is separated, and the rotation and fixing of the rotary bracket 40 can be stably performed.

### BACKGROUND OF THE INVENTION

1. Field of the Invention

The present disclosure relates to a Light Emitting Diode (LED) lighting apparatus, and more particularly, to an LED lighting apparatus in which a case configured to accommodate a power supply unit and a cover configured to be coupled to the case are capable of being easily coupled to or separated from each other.

2. Description of the Prior Art

Various types of lighting apparatuses that convert electric energy into light energy have been developed in various types, and lighting apparatuses installed to a structure, such as a building, are usually installed to the structure in a stationary form.

Recently, an LED lighting apparatus has been in the spotlight. The LED lighting apparatus uses one or more LEDs, which are mounted on a board, for lighting.

In order to supply power to an LED module so as to allow the LED module to be used for lighting, the LED lighting apparatus includes a Power Supply Unit (PSU) configured to convert the Alternating Current (AC) power of the LED module into Direct Current (DC) power of a voltage suitable for a voltage characteristic of a plurality of LED elements included in the LED module, and an LED drive unit configured to apply a current suitable for a combination of the LED elements.

However, since the power supply unit has a lifespan that is shorter than that of the LED module, the power supply unit should be more frequently replaced as compared to the LED module. Thus, the power supply unit is formed as a replaceable type in the LED lighting apparatus.

For this purpose, for example, the LED lighting apparatus includes a case configured to accommodate the power supply unit therein and a cover configured to open/close the case so that the cover may be separated as needed so as to expose and replace the power supply unit.

In addition, when it is necessary to connect an external power source to the LED lighting apparatus or to couple an electric wire connected through, for example, a sensor or a dimming device, to the LED lighting apparatus, such a connection or coupling work should be performed in a state where the case is opened.

In order to allow the cover to be separated from or coupled to the case, a coupling structure for the case and the cover or a separate coupling means (locking device) will be needed. In a conventional LED lighting apparatus, since, for example, the locking device is configured to be completely separated, a problem exists in that the locking device may be lost and re-coupling of the locking device is difficult. Further, the conventional LED lighting apparatus is weak in terms of stable coupling between the case and the cover. As a result, what is requested is to develop an LED lighting apparatus with an improved structure.

### PRIOR ART DOCUMENT

### Patent Document

(Patent Document 1) (0001) Korean Patent No. 10-1269563 (issued on May 24, 2013)
(Patent Document 2) (0002) Korean Patent No. 10-1037896 (issued on May 24, 2011)

### SUMMARY OF THE INVENTION

An object of the present disclosure is to provide an LED lighting apparatus in which a stationary bracket and a rotary bracket are operated excellently so as to ensure that a case configured to accommodate a power supply unit and a cover configured to be coupled to the case can be easily coupled to or separated from each other, and the inadvertent rotation of the rotary bracket can be prevented.

In order to accomplish this object, there is provided an LED lighting apparatus with a power supply unit. The LED lighting apparatus may include: a case configured to accommodate the power supply unit; a cover configured to be in close contact with the case so that the power supply unit is shielded; a stationary bracket configured to be coupled to the case, and including a fixing plate that is flat in a horizontal direction; and a rotary bracket configured to be coupled to the cover and to be rotated about a rotary axis orthogonal to a plane formed by the fixing plate, and including a locking plate that is parallel to the fixing plate. As the rotary bracket is rotated, the cover is separated from the case in a first range where the fixing plate and the locking plate are separated from each other, and the cover is fixed to the case in a second range where the fixing plate and the locking plate are engaged with each other.

In addition, the rotary bracket may include: a coupling plate rotatably coupled to the cover; a bent plate extending from the coupling plate and bent to a lower side of the cover; and a locking plate extending from the bent plate and spaced apart from the cover. The fixing plate and the locking plate may be configured to be engaged with each other in a state where a top surface of the locking plate faces a bottom surface of the fixing plate.

Here, the locking plate may be formed with a first fixing protrusion that protrudes toward the cover and forms a curved surface, and a distance from the cover to an upper end of the first fixing protrusion may be shorter than or equal to a distance from the cover to the bottom surface of the fixing plate.

In addition, the stationary bracket may include a coupling hole formed through the fixing plate in a vertical direction. The locking plate may be configured to be positioned in the first range or the second range depending on the rotation of the rotary bracket in a state where the locking plate has passed through the coupling hole.

In addition, the distance from the cover to the upper end of the first fixing protrusion may be shorter than the distance from the cover to the bottom surface of the fixing plate. The first fixing protrusion may be configured to be engaged with an edge of the fixing plate via the bottom surface of the fixing plate when the rotary bracket is rotated by 90° in the state where the locking plate has passed through a center of the coupling hole.

In the LED lighting apparatus according to the present disclosure, the case may include: a bottom plate configured to form a bottom surface of an accommodation space configured to accommodate the power supply unit; a first side plate configured to form a wall surface of the accommodation space; and a second side plate configured to form a wall surface of the accommodation space and spaced away from first side plate. The stationary bracket may be configured to be elastically deformed, opposite ends of the stationary bracket are fixedly coupled to the first side plate and the second side plate, respectively, and the stationary bracket may be spaced apart from the bottom plate.

In addition, the rotary bracket may further include: a guide plate extending from the locking plate and bent to the lower side of the cover. A distance from the cover to a lower end of the guide plate may be longer than the distance from the cover to the bottom surface of the fixing plate.

In the LED lighting apparatus according to the present disclosure, the coupling plate may be formed with a second fixing protrusion that protrudes toward the cover and forms a curved surface. The second fixing protrusion may be configured to come in close contact with the cover when the rotary bracket is rotated.

In addition, in the LED lighting apparatus according to the present disclosure, the cover may include a circular coupling hole that is formed through the cover in the vertical direction. The rotary bracket configured to be in close contact with the bottom surface of the cover may have a diameter larger than that of the coupling hole. The LED lighting apparatus may further include a rotary handle configured to be in close contact with a top surface of the cover and having a diameter larger than that of the coupling hole. The rotary handle may be fixedly coupled to the rotary bracket through the coupling hole.

According to the present disclosure, it is possible to provide an LED lighting apparatus, in which a cover is readily coupled and separated by a coupling structure of a stationary bracket and a rotary bracket, loss of some parts can be prevented when the cover is separated, and the rotation and fixing of a rotary bracket can be stably performed.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view illustrating an LED lighting apparatus according to an embodiment of the present disclosure;

FIG. 2 is a perspective view illustrating a state in which a cover is separated from a case in the LED lighting apparatus illustrated in FIG. 1;

FIG. 3 is a view illustrating a state in which a stationary bracket and a rotary bracket are locked or separated according to the rotation of the rotary bracket in the LED lighting apparatus according to the present disclosure;

FIG. 4 is a view illustrating the rotary bracket that is assembled to the cover in the LED lighting apparatus according to the present disclosure;

FIG. 5 is a view illustrating the rotary bracket and a rotary handle which are assembled to the cover in the LED lighting apparatus according to the present disclosure;

FIG. 6 is a view for describing a relationship between the stationary bracket and the rotary bracket in the LED lighting apparatus according to the present disclosure; and

FIG. 7 is a view illustrating a state in which the rotary handle is coupled on the cover in the LED lighting apparatus according to the present disclosure.

### DETAILED DESCRIPTION OF THE EXEMPLARY EMBODIMENTS

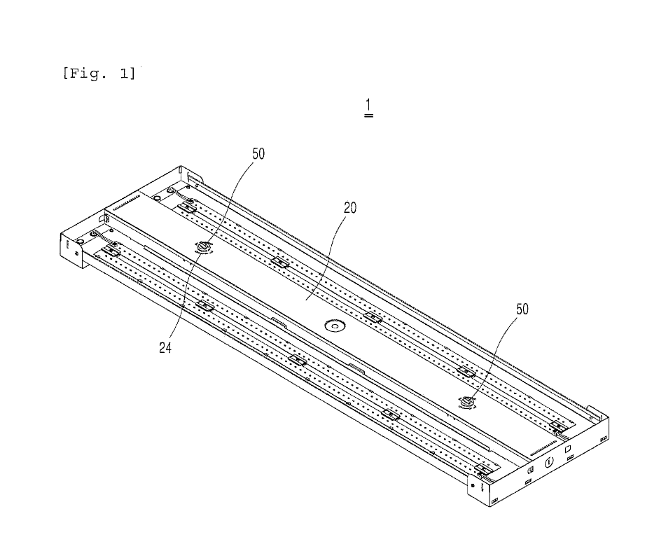

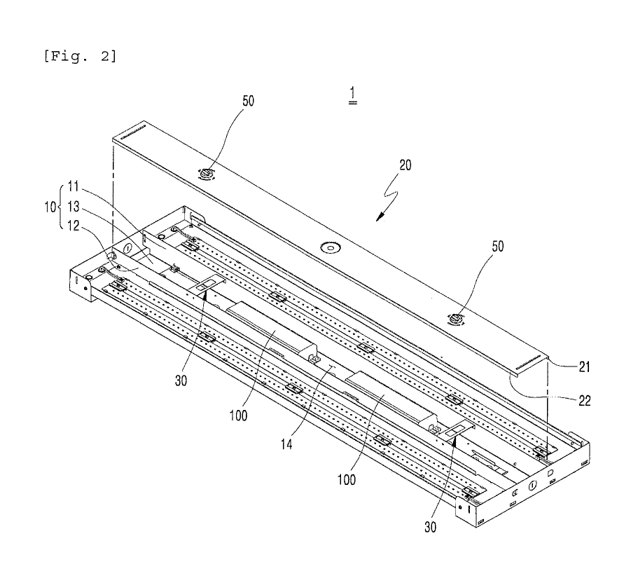

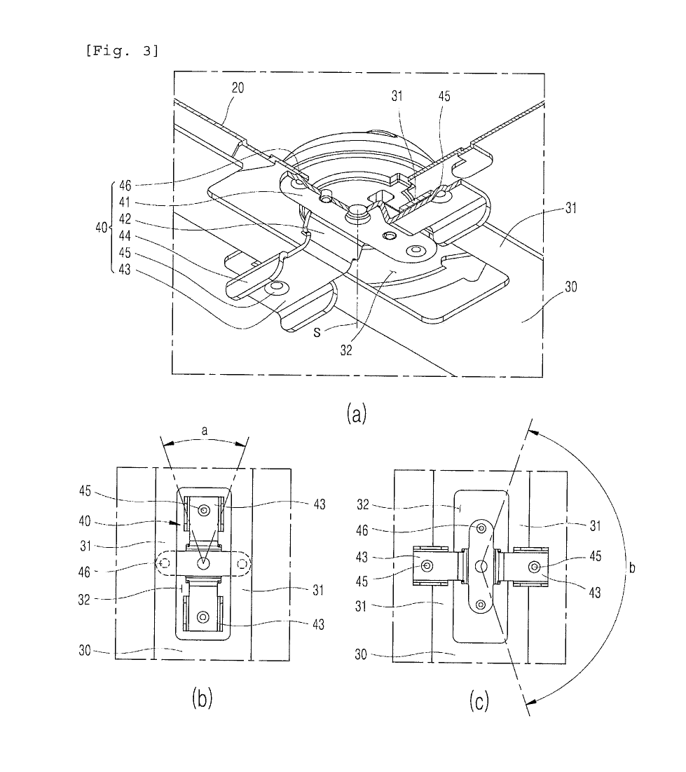

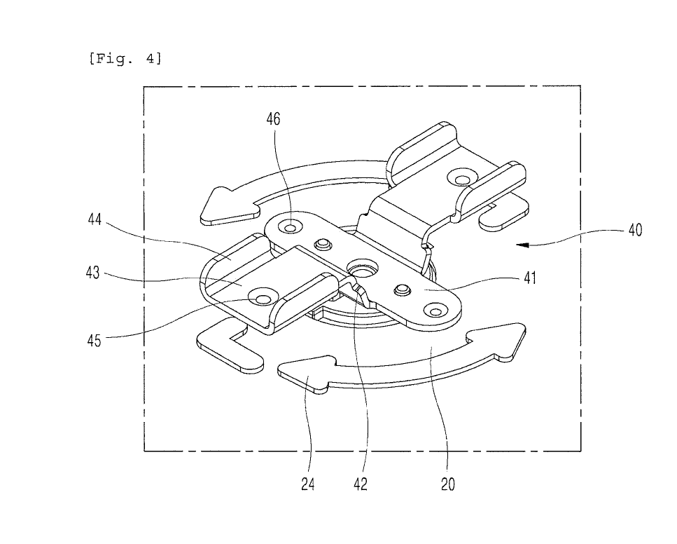

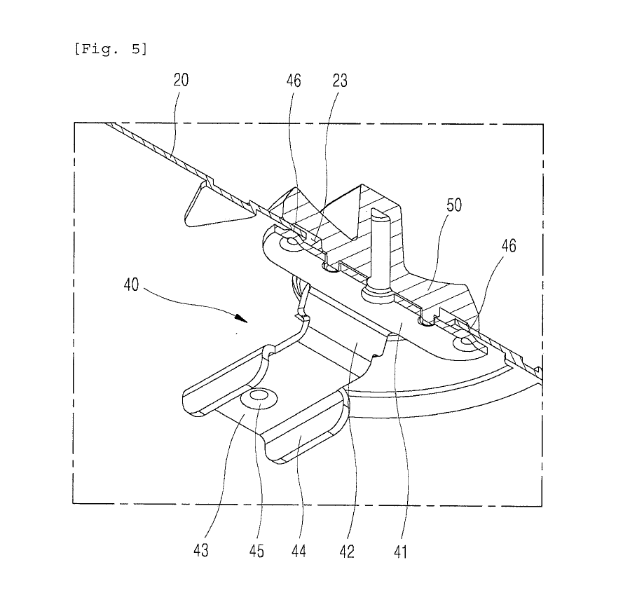

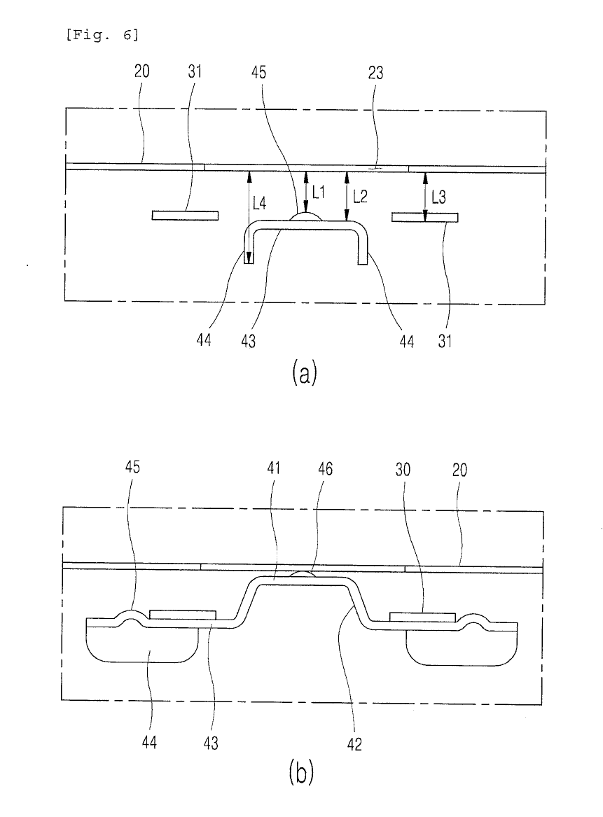

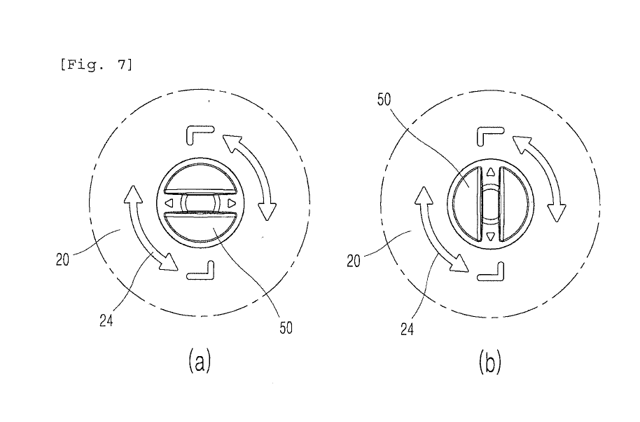

FIG. 1 is a perspective view illustrating an LED lighting apparatus 1 according to an embodiment of the present disclosure, FIG. 2 is a perspective view illustrating a state in which a cover 20 is separated from a case 10 in the LED lighting apparatus 1 illustrated in FIG. 1, and FIG. 3 is a view illustrating a state in which a stationary bracket 30 and a rotary bracket 40 are locked or separated according to the rotation of the rotary bracket 40 in the LED lighting apparatus 1 according to the present disclosure. FIG. 4 is a view illustrating the rotary bracket 40 that is assembled to the cover 20 in the LED lighting apparatus 1 according to the present disclosure, FIG. 5 is a view illustrating the rotary bracket 40 and a rotary handle 50, which are assembled to the cover 20 in the LED lighting apparatus 1 according to the present disclosure, and FIG. 6 is a view for describing a relationship between the stationary bracket 30 and the rotary bracket 40 in the LED lighting apparatus 1 according to the present disclosure. FIG. 7 is a view illustrating a state in which the rotary handle is coupled on the cover 20 in the LED lighting apparatus 1 according to the present disclosure.

FIGS. 3 and 5 illustrate some constituent elements in a cut form for the convenience of description.

The LED lighting apparatus 1 according to the present disclosure may be used by being installed to a structure, such as a building, a tunnel, or a bridge. In particular, the LED lighting apparatus 1 may be used for indoor lighting inside a building.

The LED lighting apparatus 1 according to the present disclosure is suitable to be used in the state of being installed on a ceiling of a building. Therefore, descriptions will be made on the LED lighting apparatus 1 according to the present disclosure, in which the upper and lower directions will be defined with reference to LED lighting apparatus 1 illustrated in FIGS. 1 and 2.

The LED lighting apparatus 1 uses LEDs as a light emitting means and includes a board (no reference numeral is assigned), on which a plurality of LEDs are mounted, and a Power Supply Unit (PSU) 100 configured to supply power. In particular, in order to stably and readily expose and seal the power supply unit 100, the LED lighting apparatus 1 includes a case 10, a cover 20, a stationary bracket 30, and a rotary bracket 40, and may further include a rotary handle 50.

The case 10 and the cover 20 are coupled to each other so as to form a space that accommodates and stores the power supply unit 100, and as illustrated in FIGS. 1 and 2, the case 10 and the cover 20 may be formed in an elongated box shape along the longitudinal direction of the LED lighting apparatus 1. The space defined by the case 10 and the cover 20 will be referred to as an accommodation space 14.

In the accommodation space 14 within the case 10 and the cover 20, one power supply unit 100 may be provided. Unlike this, as illustrated in FIG. 2, two or more power supply units 100 may be provided in unison.

The case 10 is formed in a top-opened shape, and may include a bottom plate 13, a first side plate 11, and a second side plate 12.

The bottom plate 13 is formed in a plate shape that is generally flat along the longitudinal direction, and the power supply units 100 are seated on the top surface of the bottom plate 13.

The first side plate 11 and the second side plate 12 are formed in a plate shape that is flat along the vertical direction, and are coupled to the bottom plate 13 so as to form the wall surface of the accommodation space 14.

Separate side plates may be coupled to the opposite ends of the first side plate 11 and the second side plate 12 so as to couple the first side plate 11 and the second side plate 12 to each other.

The cover 20 coupled to the case 10 shields the accommodation space 14 and is generally flat along the horizontal direction. The opposite edge portions of the cover 20 are bent downwardly so as to provide a first upper bent portion 21 and a second upper bent portion 22.

The first upper bent portion 21 and the second upper bent portion 22 are in close contact with the upper end portions of the outer surfaces of the first side plate 11 and the second side plate 12, respectively, so that the cover 20 and the case 10 are in close contact with each other and the power supply unit 100 is shielded. That is, the bottom surface of the cover 20 is in close contact with the upper end of the case 10, in particular the upper end edges of the first side plate 11 and the second side plate 12 so that the cover 20 and the case 10 are in close contact with each other.

In the cover 20, coupling holes 23 are formed vertically through the cover 20, and a rotary bracket 40 and a rotary handle 50 are coupled to a location where each coupling hole 23 is formed. Each coupling hole 23 is formed as a circular hole when viewed in a plan view, and has a diameter smaller than the diameters of the rotary bracket 40 and the rotary handle 50.

The rotary bracket 40 and the rotary handle 50, which are positioned on the upper and lower sides of the cover 20, respectively, with the coupling hole 23 being interposed therebetween, are coupled to the cover 20 while being fixedly coupled to each other. At this time, the rotary bracket 40 and the rotary handle 50 are coupled to be rotatable on the cover 20.

The rotary bracket 40 and the rotary handle 50 are rotatable on the cover 20 about a rotary axis S, but is in close contact with the cover 20 so as not to be movable in the vertical direction.

The rotary bracket 40 and the rotary handle 50 may be coupled to each other through various methods, such as press fit, hook coupling, or coupling using a separate coupling means, such as a bolt.

The stationary bracket 30 and the rotary bracket 40 are configured to be coupled to/separated from each other, in which the stationary bracket 30 is coupled to the case 10 and the rotary bracket 40 is coupled to the cover 20, and as the stationary bracket 30 and the rotary bracket 40 are separated from/coupled to each other, the case 10 and the cover 20 are separated from/coupled to each other.

The stationary bracket 30 is fixedly coupled to the case 10, and as illustrated in FIG. 2, the opposite ends of the bracket 30 may be coupled to the first side plate 11 and the second side plate 12, respectively. Here, the stationary bracket 30 may be spaced apart from the bottom plate 13 of the case 10.

The stationary bracket 30 is formed in a plate shape that is generally flat in the horizontal direction, and includes a locking hole 32 formed at the central portion of the stationary bracket 30 through the stationary bracket 30 in the vertical direction, and fixing plates 31 provided on opposite sides of the locking hole 32. As illustrated in FIG. 2, the locking hole 32 may be formed in a rectangular shape. Alternatively, the locking hole 32 may be formed in an oval shape elongated in the longitudinal direction of the stationary bracket 30. The locking hole 32 may be formed such that a diameter in the connecting direction of the first side plate 11 and the second side plate 12 is longer than that in the direction orthogonal thereto.

The stationary bracket 30 may be formed of, for example, a synthetic resin and a metal. The stationary bracket 30 may be formed of an elastic metal sheet.

As described above, the rotary bracket 40 is rotatably coupled on the cover 20, and the rotary shaft S of the rotary bracket 40 extends in the vertical direction and is orthogonal to the plane formed by the fixing plates 31.

The rotary bracket 40 may be sectioned into a coupling plate 41, a bent plate 42, a locking plate 43, and a guide plate 44.

The coupling plate 41 is a portion fixedly coupled to the rotary handle 50 on the coupling hole 23 of the cover 20. The center of the coupling plate 41 coincides with the center of the coupling hole 23 and the maximum diameter of the coupling plate 41 so that the cover 20 may be rotated in a state of being in close contact with the bottom surface of the cover 20 without being relatively moved upwardly.

The coupling plate 41 may be formed in a shape in which its top surface is entirely in close contact with the bottom surface of the cover 20. However, as illustrated in FIGS. 3 to 6, on the coupling plate 41, second fixing protrusions 46 may be formed to protrude toward the cover 20 and to form a curved surface. As a result, the upper ends of the second fixing protrusions 46 may be in close contact with the bottom surface of the cover 20 and the coupling plate 41 may be entirely spaced apart from the cover 20.

In addition, two or more second fixing protrusions 46 may be provided. In such a case, the second fixing protrusions 46 may be symmetrically arranged with reference to the rotary axis S.

As the second fixing protrusions 46 are made to be in close contact with the bottom surface of the cover 20, the occurrence of excessive friction when the rotary bracket 40 is rotated in relation to the cover 20 may be prevented, the cover 20 and the rotary bracket 40 may be stably coupled to each other, and the rotary bracket 40 may be smoothly rotated.

The bent plate 42 extends downwardly from one end of the coupling plate 41, and takes a form bent from the coupling plate 41. Two bent plates 42 may be provided to be arranged symmetrically with reference to the rotary axis S.

The locking plate 43 extends from the lower end of the bent plate 42 in a form bent again from the bent plate 42 and takes a plate shape that is flat in the horizontal direction. That is, the locking plate 43 is formed to be parallel to the fixing plates 31. Two locking plates 43 may be provided to be arranged symmetrically with reference to the rotary axis S. The locking plates 43 are spaced apart from the cover 20 and the fixing plates 31 are interspersed in the gap formed between the locking plates 43 and the cover 20.

The vertical distance L2 from the cover 20 to the top surface of the locking plates 43 may be set to be equal to the vertical distance L3 from the cover 20 to the bottom surface of the fixing plates 31 (with reference to a state where the locking plates 43 and the fixing plates 31 are not elastically deformed by being separated from each other without being engaged with each other).

The entire length of the locking plates 43 (the entire length of two locking plates 43 in the case where two locking plates 43 are provided) and the width of the locking plates 43 may be smaller than or equal to the length and width of the coupling hole 32, respectively. That is, the locking plates 43 are configured to be movable in the vertical direction through the coupling hole 32. Of course, the length of the locking plates 43 is longer than the width of the coupling hole 32.

As described above, the locking plates 43 pass through the coupling hole 32 in the state where the locking plates 43 and the coupling hole 32 are aligned to each other such that the longitudinal directions thereof coincide with each other, and when the rotary bracket 40 is rotated after the locking plates 43 pass through the coupling hole 32, the locking plates 43 are engaged with the fixing plates 31 such that the locking plates cannot be released again through the coupling hole 32.

The guide plates 44 extend downwardly from one end of the locking plates 43 to be bent from the locking plates 43. Two guide plates 44 may be provided in each of the locking plates 43. In such a case, the guide plates 44 may be symmetrically arranged on both sides of the locking plates 43.

The vertical distance L4 from the cover 20 to the lower ends of the guide plate 44 is longer than the vertical distance L3 from the cover 20 to the bottom surface of the fixing plates 31 (with reference to the state where the locking plates 43 and the fixing plates 31 are not elastically deformed by being separated from each other without being engaged with each other).

The outer surfaces of the connection portions between the guide plates 44 and the locking plates 43 may be rounded, so that, when the rotary bracket 40 is rotated, the locking plates 43 are guided to move smoothly to the lower side of the fixing plates 31.

On each of the locking plate 43, a first fixing protrusion 45 is formed to protrude toward the cover 20 and to form a curved surface.

The vertical distance L1 from the cover 20 to the upper ends of the first fixing protrusions 45 is shorter than or equal to the vertical length L3 from the cover 20 to the bottom surfaces of the fixing plates 31 (with reference to the state where the locking plates 43 and the fixing plates 31 are not elastically deformed by being separated from each other without being engaged with each other).

As a result, the upper ends of the first fixing protrusions 45 are in close contact with the bottom surfaces of the fixing plates 31 in the state where the fixing plates 31 and the locking plates 43 face each other, and the locking plates 43 may be entirely spaced apart from the fixing plates 31 (at this time, the fixing plates 31 and/or the locking plates 43 may be elastically supported by one another while being elastically deformed).

One first fixing protrusion 45 may be provided on each locking plate 43. In such a case, the first fixing protrusions 45 formed on respective locking plates 43 may be symmetric to each other with reference to the rotary axis S.

As the first fixing protrusions 45 are in close contact with the bottom surfaces of the fixing plates 31, the occurrence of excessive friction between the stationary bracket 30 and the rotary bracket 40 may be prevented when the rotary bracket 40 is rotated in relation to the stationary bracket 30, and the rotary bracket 40 may be stably and smoothly rotated and stably positioned.

In the LED lighting apparatus 1 according to the present disclosure, the distance from the rotary axis S to the first fixing protrusions 45 is somewhat longer than the shortest distance from the rotary axis S to the outermost end edges of the fixing plates 31. For example, when the radius of the fixing protrusions (on the plan view) is r, the horizontal distance from the rotary axis S to the center of each first fixing protrusion 45 is longer than the shortest distance (horizontal distance) from the rotary axis S to outer end edges of the fixing plates 31 by x, in which a relationship of 0<x≦r is formed.

As a result, when the rotary bracket 40 is rotated by 90° in the state where the locking plates 43 have passed through the center of the coupling hole 32, the first fixing protrusions 45 are engaged with the outer edges of the fixing plates 31 via the bottom surfaces of the fixing plates 31, and in a state where no separate external force is applied, the state, in which the first fixing protrusions 45 are engaged with the outer edges of the fixing plates 31, is maintained.

This will prevent the rotary brackets 40 from being inadvertently rotated, and will allow the rotary bracket 40 and the stationary bracket 30 to maintain a stably fixed state therebetween.

Each rotary handle 50 is coupled on the top surface of the cover 20 and is formed in a circular form on a plan view. The rotary handle 50 is provided with a handle (no reference numeral is assigned) on the upper side thereof so that the user may easily grip the rotary handle. When the user grips the handle and rotates the rotary handle 50, the corresponding rotary bracket 40 can be rotated about the rotary axis S.

The rotary handle 50 and/or the cover 20 may be indicated with an indicator 24 so that the rotated extent (locked or opened) of the rotary handle 50 and the rotary bracket 40 can be easily determined, and such an indicator 24 may be formed by, for example, a character, a number, or a symbol.

Hereinafter, descriptions will be made on a use method of the LED lighting apparatus 1 according to the present disclosure.

Descriptions will be made assuming that the case 10 and the cover 20 are operated from the state where the case 10 and the cover 20 are separated from each other as illustrated in FIG. 2 to the state where the case 10 and the cover 20 are coupled to each other as illustrate in FIG. 1.

First, in the state where the locking plate 43 and the coupling hole 32 are aligned to each other to coincide with each other in the longitudinal directions thereof, the stationary bracket 30 and the rotary bracket 40 are brought close to each other.

As a result, the locking plates 43 pass through the coupling hole 32 and the cover 20 comes into close contact with the case 10.

In this state, when the cover 20 is spaced apart from the case 10 (in the vertical direction), of course, the locking plates 43 are not engaged with the fixing plates 31 to be separated again.

In addition, in such a state, the rotary bracket 40 can be rotated about the rotary axis S, and when the rotary bracket 40 is rotated beyond a predetermined angle, the locking plates 43 are moved to the lower side of the fixing plates 31 so that the locking plates 43 and the fixing plates 31 are engaged with each other.

However, depending on the size of the coupling hole 32, the locking plates 43 and the fixing plates 31 may not be engaged with each other, even if the rotary bracket 40 is slightly rotated. The range, in which the locking plates 43 and the fixing plates 31 are engaged with each other, will be referred to as a first range a (see FIGS. 3b and 6a).

That is, the first range a refers to an angular range in which the locking plates 43 and the fixing plates 31 are not engaged with each other in the rotating range of the rotary bracket 40.

When the rotating range of the rotary bracket 40 exceeds the first range a, the locking plates 43 are moved to the lower side of the fixing plates 31 so that the locking plates 43 and the fixing plates 31 are engaged with each other. At this time, the guide plates 44 may allow the locking plates 43 to smoothly move to the lower side of the fixing plates 31, and the first fixing protrusions 45 may come in close contact with the fixing plates 31.

When the rotary bracket 40 is further rotated so that the locking plates 43 and the coupling hole 32 are rotated by 90° from the initial state where the locking plates 43 and the coupling hole 32 are aligned to coincide with each other in the longitudinal directions thereof, the first fixing protrusions 45 are engaged with the edges of the fixing plates 31 via the bottom surfaces of the fixing plates 31.

In such a state, even if the rotary bracket 40 is rotated slightly more or less, the engagement between the locking plates 43 and the fixing plates 31 are maintained. The range, in which the engagement between the locking plates 43 and the fixing plates 31 is maintained, will be referred to as a second range b (see FIGS. 3c and 6b).

That is, the second range b refers to a range, in which the engagement between the locking plates 43 and the fixing plates 31 is maintained in the angular rotating range of the rotary bracket 40.

In the present disclosure, the second range b may be set to be larger than the first range a. In particular, the second range b may be set to twice the first range a or more. As a result, it is possible to efficiently prevent the cover 20 from being inadvertently separated from the case 10.

As described above, according to the present disclosure, it is possible to provide an LED lighting apparatus 1, in which the separation and coupling of the cover 20 can be readily performed by the coupling structure of the stationary bracket 30 and the rotary bracket 40, the loss of some parts can be prevented when the cover 20 is separated, and the rotation and fixing of the rotary bracket 40 can be stably performed.

Although the exemplary embodiment of the present invention is described and shown, it is obvious to a person skilled in the art that the present invention is not limited to the described embodiment and may be changed and modified in various forms without departing from the spirit and scope of the present invention. Accordingly, modifications or variations should not be individually understood in view of the technical spirit of the present invention, and it must be understood the modifications and the variations belong to the claims of the present invention.

What is claimed is:

1. An LED lighting apparatus with a power supply unit, the LED lighting apparatus comprising:
a case configured to accommodate the power supply unit;
a cover configured to be in close contact with the case so that the power supply unit is shielded;
a stationary bracket configured to be coupled to the case, the stationary bracket including a fixing plate that is flat in a horizontal direction; and
a rotary bracket configured to be coupled to the cover and to be rotated about a rotary axis orthogonal to a plane formed by the fixing plate, the rotary bracket including a locking plate that is parallel to the fixing plate,
wherein, as the rotary bracket is rotated, the cover is separated from the case in a first range where the fixing plate and the locking plate are separated from each other, and the cover is fixed to the case in a second range where the fixing plate and the locking plate are engaged with each other.

2. The LED lighting apparatus of claim 1, wherein the rotary bracket includes:
a coupling plate rotatably coupled to the cover;
a bent plate extending from the coupling plate and bent to a lower side of the cover; and
a locking plate extending from the bent plate and spaced apart from the cover,
wherein the fixing plate and the locking plate are configured to be engaged with each other in a state where a top surface of the locking plate faces a bottom surface of the fixing plate.

3. The LED lighting apparatus of claim 2, wherein the locking plate is formed with a first fixing protrusion that protrudes toward the cover and forms a curved surface, and
a distance from the cover to an upper end of the first fixing protrusion is shorter than or equal to a distance from the cover to the bottom surface of the fixing plate.

4. The LED lighting apparatus of claim 3, wherein the stationary bracket includes a coupling hole formed through the fixing plate in a vertical direction, and
the locking plate is configured to be positioned in the first range or the second range depending on the rotation of the rotary bracket in a state where the locking plate has passed through the coupling hole.

5. The LED lighting apparatus of claim 4, wherein the distance from the cover to the upper end of the first fixing protrusion is shorter than the distance from the cover to the bottom surface of the fixing plate, and
the first fixing protrusion is configured to be engaged with an edge of the fixing plate via the bottom surface of the fixing plate when the rotary bracket is rotated by 90° in the state where the locking plate has passed through a center of the coupling hole.

6. The LED lighting apparatus of claim 2, wherein the case includes:
a bottom plate configured to form a bottom surface of an accommodation space configured to accommodate the power supply unit;
a first side plate configured to form a wall surface of the accommodation space; and
a second side plate configured to form a wall surface of the accommodation space and spaced away from first side plate, and
wherein the stationary bracket is configured to be elastically deformed, opposite ends of the stationary bracket are fixedly coupled to the first side plate and the second side plate, respectively, and the stationary bracket is spaced apart from the bottom plate.

7. The LED lighting apparatus of claim 2, wherein the rotary bracket further includes a guide plate extending from the locking plate and bent to the lower side of the cover, and
a distance from the cover to a lower end of the guide plate is longer than the distance from the cover to the bottom surface of the fixing plate.

8. The LED lighting apparatus of claim 2, wherein the coupling plate is formed with a second fixing protrusion that protrudes toward the cover and forms a curved surface, and
the second fixing protrusion is configured to come in close contact with the cover when the rotary bracket is rotated.

9. The LED lighting apparatus of claim 1, wherein the cover includes a circular coupling hole that is formed through the cover in the vertical direction,
the rotary bracket configured to be in close contact with the bottom surface of the cover has a diameter larger than that of the coupling hole, and
the LED lighting apparatus further includes a rotary handle configured to be in close contact with a top surface of the cover and having a diameter larger than that of the coupling hole, the rotary handle being fixedly coupled to the rotary bracket through the coupling hole.
